(19) United States
(12) Patent Application Publication
(10) Pub. No.: US 2005/0183904 A1
(43) Pub. Date: Aug. 25, 2005

(54) Device for installing and removing carabiners and for the attachment of a handheld brush

(76) Inventor: Pat Wilbur Bacalso, Calgary (CA)

Correspondence Address: PAT WILBUR BACALSO, 243159 PARADISE RD., BOX 28 SITE 2 RR# 6, CALGARY, T2M 4L5, CA

(21) Appl. No.: 10/781,096

(22) Filed: Feb. 19, 2004

(51) Int. Cl. A62B 1/16; A47L 3/04; E06C 7/18

(52) U.S. Cl. 182/5

(57) ABSTRACT

This invention relates to the sport of rock climbing. It is a device which is used in aiding the placement and removal of safety equipment on a rock face which would normally be out of the reach for the average person. The same device also facilitates the secure attachment of a hand held brush at various angles which is used for the removal of debris on climbing holds such as dirt or gym chalk from other climbers. Device for installing and removing carabiners and for the attachment of a handheld brush

### BACKGROUND OF INVENTION

Rock climbing has, inherently, always been a dangerous activity. The proper use of safety equipment significantly reduces the chance of injury when scaling a rock face. Equipment such as a harness, rope and carabiners are commonly used by most climbers.

In order for a climber to be protected from a fall, he or she must wear a harness which has a climbing rope tied to it. As the climber ascends up the rock-face, he places a carabiner into a “hanger” which has been bolted or glued into the rock at regular intervals. A hanger is typically a formed piece of metal with a hole in it which allows a carabiner to be clipped into it. The carabiner which is clipped into this hanger typically has a high strength fabric loop attached to it which is then attached to another carabiner. This fabric loop is typically known as a “sling”. The two carabiners in combination with the sling are typically known as a “quick draw”. Once the quick draw is securely installed into the hanger, the climber then places the attached rope into the lower carabiner of the quickdraw. The rope is also attached to a person on the ground who is also wearing a harness and a device which controls the amount and the rate at which the climber receives the rope. In the event of a fall, the person on the ground would stop the rope from feeding through their device, consequently preventing the climber from hitting the ground.

Before a climber can truly be safe on a climb, he must have his quickdraw and attached rope placed into the first hanger of a climb before ascending. Therefore a device was needed to place that quickdraw into that first hanger and in some instances the ability to remove quick draws from a hanger. U.S. Pat. No. 5,235,248 to AmRhein describes a device which is capable of accomplishing these tasks. Although effective, this device is relatively inefficient, large and somewhat cumbersome with it's moving parts.

### SUMMARY OF THE INVENTION

In accordance with one embodiment of the present invention, it is an object of the present invention to provide a device and method which is able to install a quick draw into a hanger which is beyond the reach of the user.

It is another object of the present invention to provide a device and method for removing an installed quickdraw from a hanger which is beyond the reach of the user.

It is yet another object of the present invention to provide a device which securely holds a hand held brush at various angles for the removal of debris from climbing holds which are beyond the reach of the user.

### BRIEF DESCRIPTION OF DRAWINGS

FIG. 1 is a frontal perspective view of the present invention.

FIG. 2 is rear perspective view of the present invention.

FIG. 3A is a frontal view of the present invention supporting a carabiner with it's opening oriented to the right.

FIG. 3B is a frontal view of the present invention supporting a carabiner with it's opening oriented to the left.

FIG. 4A is a cross sectional side view of the present invention holding a brush at a diagonal angle.

FIG. 4B is a cross sectional side view of the present invention holding a brush at a near vertical angle.

FIG. 4C is a cross sectional rear view of the present invention holding a brush at a horizontal angle.

FIG. 5A is a perspective side view of the present invention inserting a quick draw into a hanger.

FIG. 5B is a perspective side view of a quickdraw disengaging from the present invention once it is installed into a hanger.

FIG. 6A is of a frontal view of the first step of the present invention removing an installed quick draw.

FIG. 6B is of a frontal view of the second step of the present invention removing an installed quick draw.

FIG. 6C is of a frontal view of the third step of the present invention removing an installed quick draw.

FIG. 7A is a side view of the first step of the present invention removing an installed quick draw.

FIG. 7B is a side view of the second step of the present invention removing an installed quick draw.

FIG. 7C is a side view of the third step of the present invention removing an installed quick draw.

### DETAILED DESCRIPTION OF THE PREFERRED EMBODIMENT

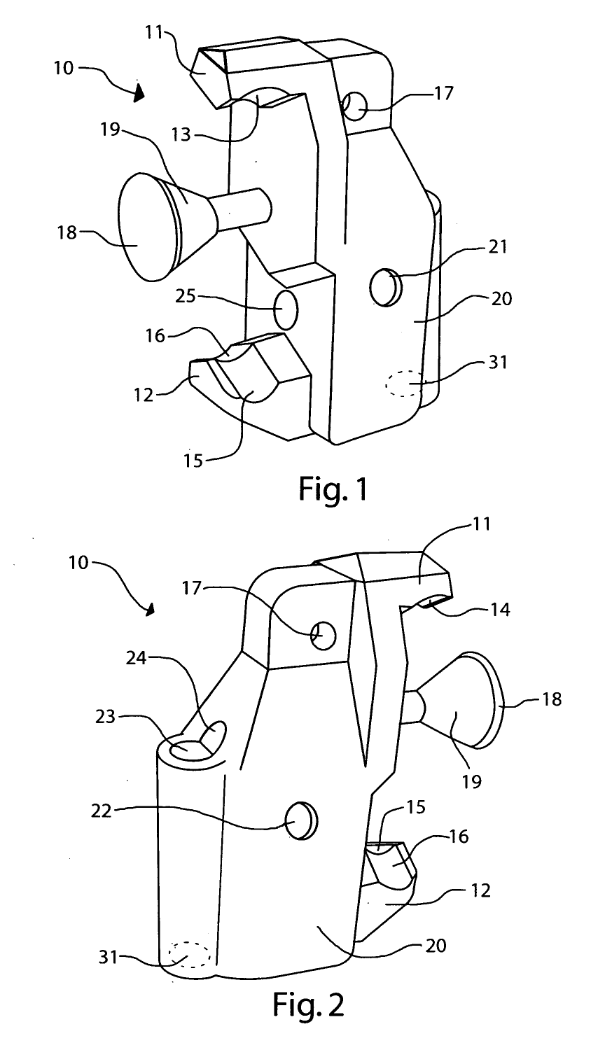

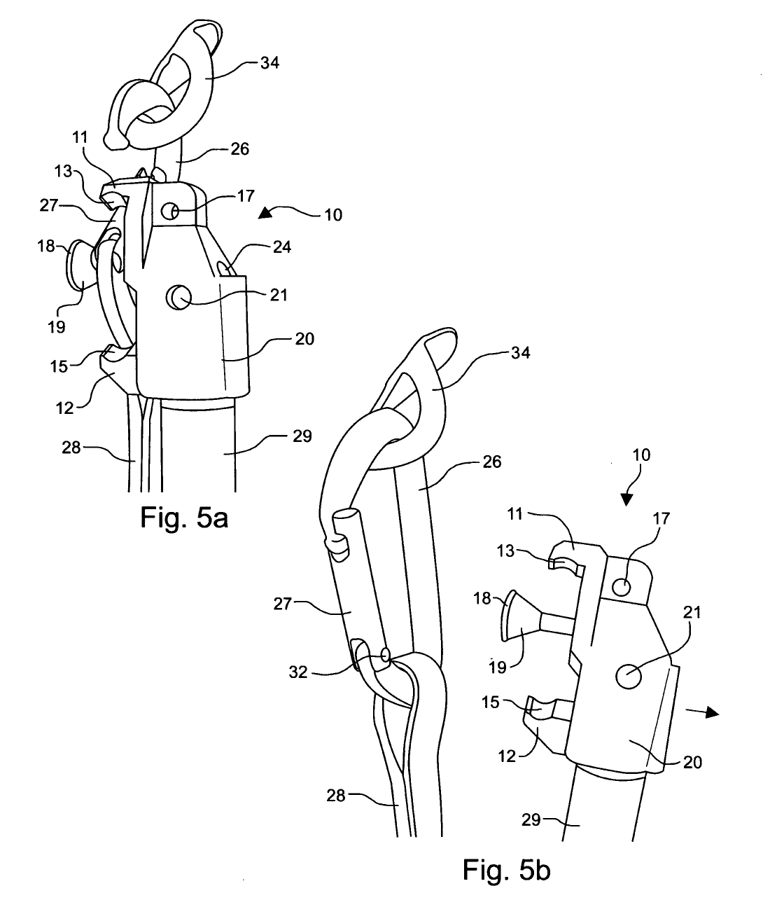

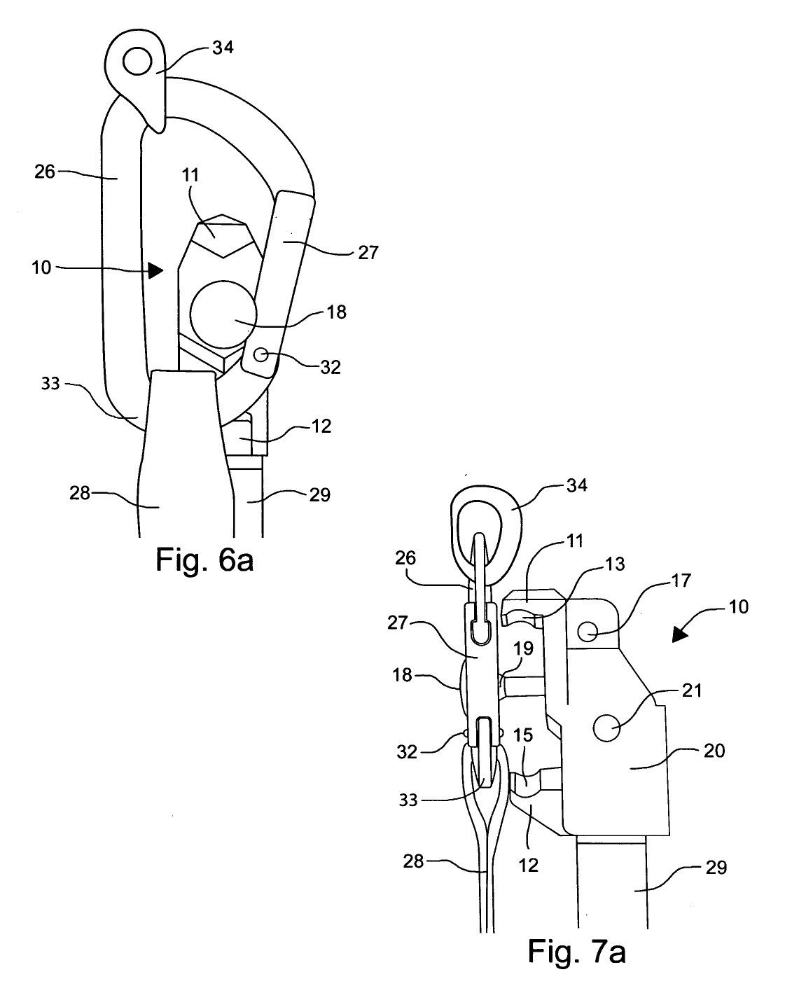

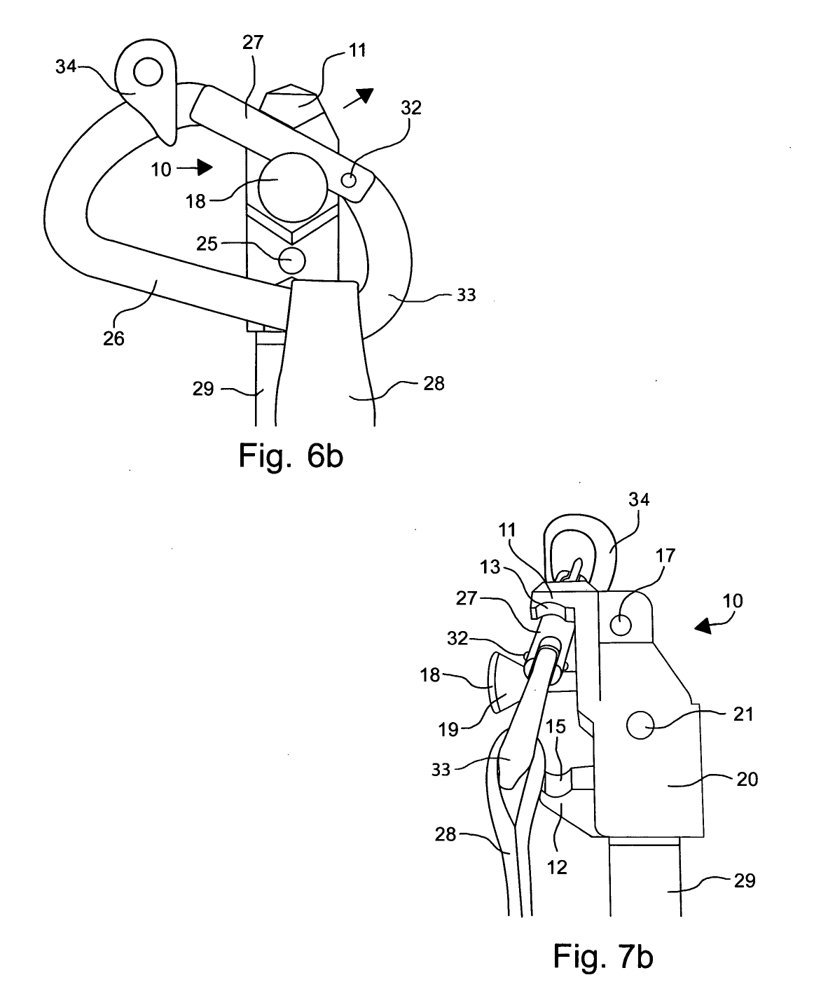

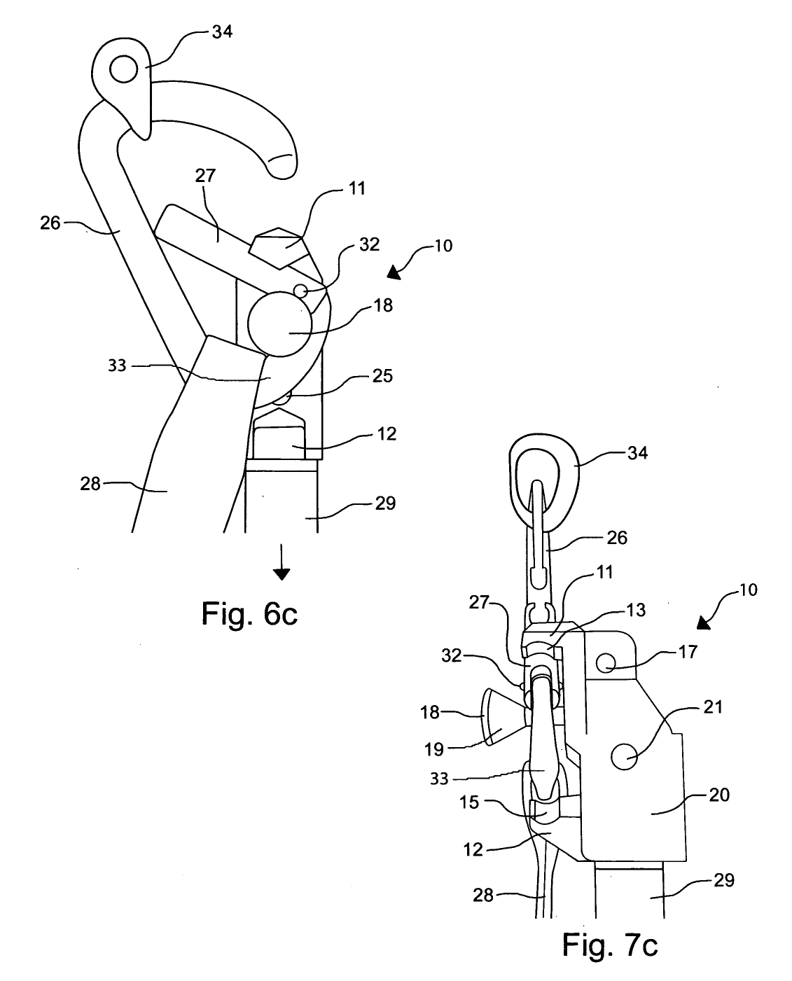

Referring to FIG. 1 a device 10 is shown. The device 10 is used to install a carabiner 26 into a hanger 34 as shown in FIGS. 5a and 5b as well as remove an installed carabiner 26 which is out of reach for the user as shown in FIGS. 6a, 6b, 6c, 7a, 7b and 7c. The device 10 is also used to securely hold a handheld brush 30 at various angles for removing dust and debris from climbing holds as shown in FIGS. 4a, 4b and 4c.

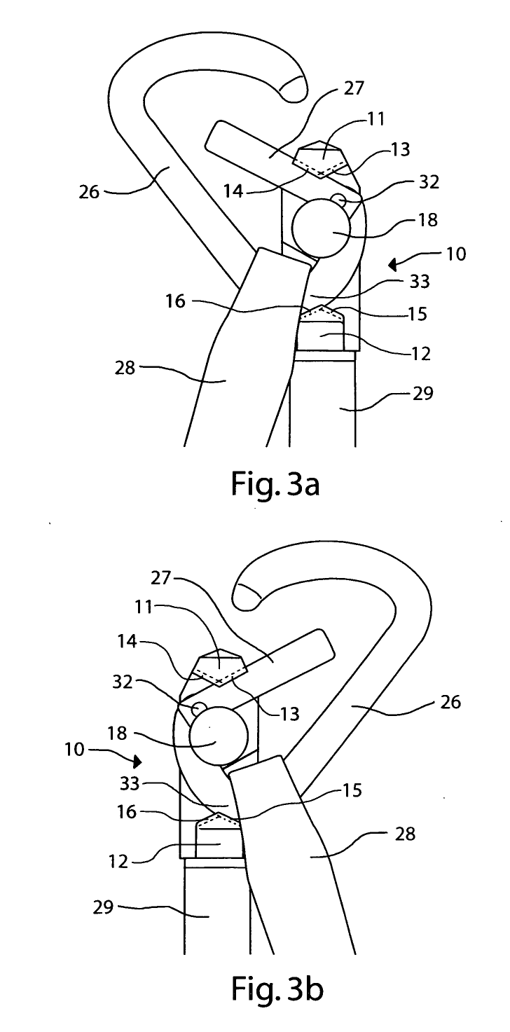

The present invention 10 is comprised of a main body section 20 with a substantially flat rectangular face. The main body section 20 is internally threaded which facilitates the coupling of an extension device 29 such as a broom handle or telescopic painters pole. The substantially flat rectangular face is comprised of a top protruding member 11, a bottom protruding member 12 and a protruding bolt with an extra wide head 18 in between the top protruding member 11 and the bottom protruding member 12. The top protruding member 11 has two shallow grooves 13 and 14 which are at opposing angles to one another as shown in FIG. 1 and FIG. 2. The bottom protruding member 12 has two shallow grooves 15 and 16 which are at opposing angles to one another as shown in FIG. 1. A conical sleeve 19 is securely placed onto the protruding bolt 18 as shown in FIG. 1. A hole 24 is drilled at an downward diagonal angle near the top rear of the main body section 20 until it creates another hole 25 on the substantially rectangular face as shown in FIG. 1 and FIG. 2. The passageway created, partially intersects with the threaded area of the main body section 20 as shown in FIG. 4a.

A hole 23 is drilled at a near vertical downward angle near the top rear of the main body section 20 until it creates another hole 31 at the bottom rear of the main body section 20. The passageway created, partially intersects with the threaded area of the main body section 20 as shown in FIG. 4b. The hole 23 also partially intersects with the adjacent hole 24. A hole 21 is drilled at a horizontal angle on the side of the main body section 20 until it creates another hole 22 on the opposite side of the main body section 20. The passageway created, partially intersects with the threaded area of the main body section 20 as shown in FIG. 4c. A hole 17 is drilled horizontally near the top of the main body section which facilitates the addition of a cord utility loop as shown in FIG. 1 and FIG. 2.

Operation

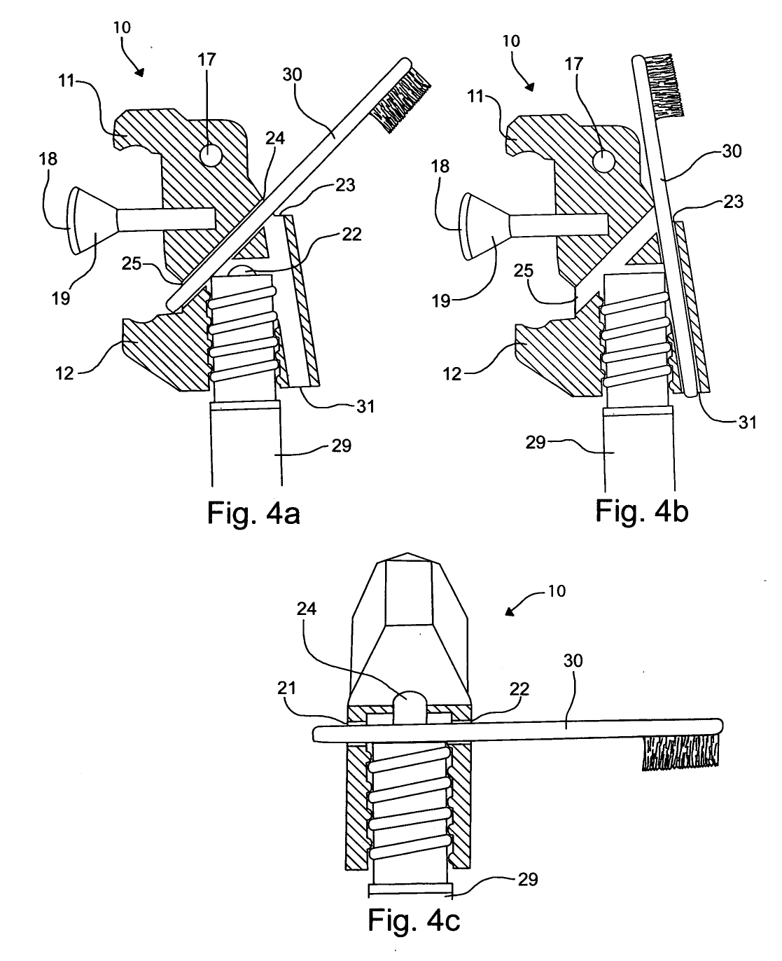

In order to install a carabiner 26 onto a hanger 34, the device 10 must first be coupled to some form of extension device 29 such as a broom handle or telescopic painter's pole. A carabiner 26 must then be loaded into the device 10. The spring-loaded gate 27 of the carabiner 26 is placed in between the top protruding member 11 and the protruding bolt 18. The bottom of the carabiner 33 is placed in between the protruding bolt 18 and the bottom protruding member 12. In this orientation, the spring-loaded gate 27 of the carabiner 26 is pressed into the groove 14 of the top protruding member 11, while the bottom of the carabiner 33 is pressed into the groove 16 of the bottom protruding member 12 as shown in FIG. 3a. It is also possible to load the device 10 with a carabiner 26 facing the opposite direction. The spring-loaded gate 27 of the carabiner 26 is placed in between the top protruding member 11 and the protruding bolt 18. The bottom of the carabiner 33 is placed in between the protruding bolt 18 and the lower protruding member 12. In this orientation, the spring-loaded gate 27 of the carabiner 26 is pressed into the groove 13 of the top protruding member 11, while the bottom of the carabiner 33 is pressed into the groove 15 of the bottom protruding member 12 as shown in FIG. 3b.

The user would then raise the device 10 with a loaded carabiner 26 up to a hanger 34 and then place it within the hanger 34 as shown in FIG. 5a. The user would then pull the device 10 away from the hanger 34. This action would cause the carabiner 26 to disengage from the device 10 while at the same time causing the spring loaded gate 27 of the carabiner 26 to close while on the hanger 34 as shown in FIG. 5b. It is also possible to install a carabiner 26 with its opening oriented in the opposite direction.

In order to remove an installed carabiner 26, the user must first align the conical sleeve 19 on the protruding bolt 18 along the inside of the spring-loaded gate 27, just above it's pivot point 32 as shown in FIG. 6a and FIG. 7a. The user must then lift the carabiner 26 at an upward angle using the protruding bolt 18. The carabiner 26 is lifted until the spring-loaded gate 27 is parallel with the edge of the top protruding member 11 as shown in FIG. 6b. It is at this point that the spring-loaded gate 27 slides down the conical sleeve 19 and rests directly underneath the top protruding member 11 as shown in FIG. 7b. The user then pulls the device 10 down, thereby trapping the spring-loaded gate 27 underneath the top protruding member 11 and causing it to open while at the same time, the sling 28 is pushed aside as shown in FIG. 6c. When the bottom of the carabiner 33 rises above the edge of the bottom protruding member 12, the carabiner 26 straightens itself into a vertical orientation directly above the bottom protruding member 12 as shown in FIG. 7c. The user then releases the downward tension exerted on the carabiner 26. The spring mechanism within the gate 27 presses the bottom of the carabiner 33 into the groove 16 of the bottom protruding member 12 while at the same time it is pressing the gate 27 into the groove 14 of the top protruding member 11 as shown in FIG. 3a. With the carabiner 26 supported and the spring-loaded gate 27 held open, the user can now remove the carabiner 26 from the hanger 34. It should be noted that the device 10 can remove an installed carabiner 26 facing the opposite direction as well.

In order to securely attach a handheld brush 30 at a diagonal angle to the device 10, the user must first insert the handheld brush 30 into the hole 24 with the end of the handheld brush 30 protruding from the hole 25 located on the rectangular face. The user then threads the extension device 29 into the device 10 until it binds the handheld brush 30 against the top corner of the threaded section of the device 10 as shown in FIG. 4a.

In order to securely attach a handheld brush 30 at a near vertical angle to the device 10, the user must first insert the handheld brush 30 into the hole 23 with the end of the handheld brush 30 protruding from the hole 31 located at the bottom rear of the device 10. The user then threads the extension device 29 into the device 10 until it binds the handheld brush 30 against the inner wall of the device 10 as shown in FIG. 4b.

In order to securely attach a handheld brush 30 at a horizontal angle to the device 10, the user must first insert the handheld brush 30 into the hole 22 with the end of the handheld brush 30 protruding from the hole 21 located on the opposite side of the device 10. The user then threads the extension device 29 into the device 10 until it binds the handheld brush 30 against the top of the threaded section of the device 10 as shown in FIG. 4c. The invention is not limited by the embodiments descried above which are presented as examples only but can be modified in various ways within the scope of protection defined by the appended patent claims.

1. A device for installing and removing a carabiner and for securely attaching a hand held brush at various angles for the removal of dust and debris from climbing holds comprising an; internally threaded main body section with a substantially rectangular face.

2. The device in accordance with claim 1 wherein the internally threaded main body section has a horizontal passageway used for the secure attachment of a handheld brush which partially intersects the internally threaded section.

3. The device in accordance with claim 1 wherein the internally threaded main body section has a diagonal passageway used for the secure attachment of a handheld brush which partially intersects the internally threaded section.

4. The device in accordance with claim 1 wherein the internally threaded main body section has a near vertical passageway used for the secure attachment of a handheld brush which partially intersects the internally threaded section

5. The device in accordance with claim 1 wherein the substantially rectangular face is comprised of; a top protruding member, a protruding bolt and a lower protruding member.

6. The device in accordance with claim 5 wherein the top protruding member has two intersecting grooves at opposing angles to one another.

7. The device in accordance with claim 5 wherein a conical sleeve is attached to the protruding bolt.

8. The device in accordance with claim 5 wherein the bottom protruding member has two intersecting grooves at opposing angles to one another.

9. The device in accordance with claim 1 wherein the internally threaded main body section has a horizontal passageway used for the attachment of a cord utility loop.
